(19) United States
(12) Patent Application Publication
(10) Pub. No.: US 2010/0154376 A1
(43) Pub. Date: Jun. 24, 2010

(54) INHERENTLY COLOURED POLYESTER POLYMERS, FIBERS OR FILAMENTS AND PROCESS FOR PRODUCING THEM

(75) Inventors: Vikas Madhusudan Nadkarni, Maharashtra (IN); Subbiah Venkatachalam, Maharashtra (IN); Jayprakash Vinayak Labde, Maharashtra (IN); Kirti Gajanan Patil, Maharashtra (IN); Milind Satish Vaidya, Maharashtra (IN)

Correspondence Address: KLEIN, O''Neill & SINGH, LLP, 18200 Von Karman Avenue, Suite 725, IRVINE, CA, 92612, US

(73) Assignee: RELIANCE INDUSTRIES LTD, Dist-Taigad, Maharashtra (IN)

(21) Appl. No.: 12/063,418

(22) PCT Filed: Aug. 8, 2006
(86) PCT No.: PCT/IN2006/000293

§ 371 Date: Feb. 8, 2008

(30) Foreign Application Priority Data
Aug. 10, 2005 (IN) 931/MUM/2005

(51) Int. Cl. D02G 3/02; C08G 63/00; C08G 73/06; C08G 79/00; B29C 47/04

(52) U.S. Cl. 57/243; 528/271; 528/327; 528/9; 264/75

(57) ABSTRACT

Inherently colored polyester polymers with controlled branching include a chromophoric co-monomer in their backbone. The chromophoric co-monomer may be a carboxyl terminated chromophoric co-monomer. such as metallo-phthalocyanine tetracarboxylic acid. The inherently colored polyester polymer may be melt-spun into a filament or fiber.

### FIELD OF THE INVENTION

The invention relates to inherently coloured polyester polymers, fibres or filaments. Particularly, the invention relates to the inherently coloured polyester polymers, fibers or filaments comprising chromophoric co-monomers in their backbone.

The invention also relates to a process for preparing the above inherently coloured polyester polymers, fibers or filaments.

The invention also relates to use of the above inherently coloured polyester polymers, fibers or filaments in various forms/applications but not restricted to fibres, filament yarns, bottles, molded articles etc.

### BACKGROUND OF THE INVENTION

Polyester fibres/filaments are inherently difficult to dye and require high pressure and temperature for the same. Moreover, dyeing procedure in itself is not eco-friendly and also it involves extensive use of water that gets polluted and hence need to be treated before it can be released outside. Similarly polyester articles like bottles, containers, etc are colored by the use of colorants, pigments, masterbatches, etc that can give non-uniform colours especially with darker shades.

Due to the above reasons it would be highly advantageous to have colourants that form part of the polymer backbone thus eliminating the need for dyeing and the need for adding pigments, colorants, masterbatches, etc. There have been some attempts earlier towards attaining this goal in polyester where chromophore co-monomers with either carboxyl functional or hydroxyl functional end groups were used, but with limited success. But these chromophoric monomers have disadvantages, like carboxyl functional chromophoric co-monomers have very low reaction rates and hydroxyl functional chromophoric monomers are not thermally stable, and hence the latter need to be added only towards the later stages of the process; particularly after oligomerization but before polycondensation or during injection molding. Thus the experimental conditions or parameters are critical and are required to be controlled. This can be a disadvantage, as it requires the end user, who is generally different from the polyester manufacturer, to have the capabilities to handle coloured materials. Also if such choromophores are added in the reactor, it results in dye carryover leading to loss of monomer and thus the process is not economically viable.

U.S. Pat. No. 3,525,714 reports incorporation of tetracarboxylic copper phthalocyanine into polyester backbone to prepare coloured fiber and film forming polyester exhibiting uniform and resistant self colour. But incorporating the monomer in its neat and ester forms could lead to localized gelling and which could give problems during spinning. Also the branching leads to a loss in crystallization that can ultimately lead to loss of important properties like tenacity, elongation, etc of the fibre.

U.S. Pat. No. 6,635,350 reports incorporation of hydroxyl terminated anthraquinone derivative into polyester backbone to obtain red polymeric colorant that is easy to process, mixes well within target plastics and provides excellent colorations within the target finished articles. Incorporation of this monomer during the initial reaction stages leading to dye carryover and hence required to be added only during the final extrusion stages. This makes the process economically unviable.

Thus prior arts claim inherently coloured polyester using either carboxyl terminated or hydroxyl terminated chromophoric monomers. These chromophoric monomers are either added towards the end of reaction or directly at the point of injection molding as they are either less soluble in monoethylene glycol or they get carried over along with the condensed vapours. Hence it adds additional cost to the product. Further the tetra functional carboxyl terminated chromophoric co-monomer is not readily soluble in monoethylene glycol and therefore, direct incorporation in esterification reaction is not easily possible. The unreacted chromophoric co-monomer left in the polymer due to poor solubility leads to choking in filter packs and therefore causes disruption in spinning process. Also, there is a possibility for branching, crosslinking or gel formation due to tetra functionality and hence they are not suitable for making fibers.

### OBJECTS OF THE INVENTION

An object of the invention is to provide inherently coloured polyester polymers, fibers or filaments with controlled branching or even linear structures.

Another object of the invention is to provide inherently coloured polyester polymers, fibers or filaments with controlled branching or even linear structures, where the inherently coloured polyester is economical.

Another object of the invention is to provide inherently coloured polyesters, fibers or filaments with controlled branching or even linear structures, where inherently coloured polyester is eco-friendly and safe.

Another object of the invention is to provide a process for the preparation of inherently coloured polyester polymers, fibers or filaments wherein hydroxyl terminated monomers are added to tailor the functionality of the tetra-functional carboxyl terminated chromophoric co-monomer to obtain controlled branching and linear structures.

Another object of the invention is to provide a process for the preparation of inherently coloured polyester polymers, fibers or filaments with controlled branching or even linear structures, where the process is simple, easy and convenient to carry out.

Another object of the invention is to provide a process for the preparation of inherently coloured polyester polymers, fibers or filaments with controlled branching or even linear structures, where the process is cost-effective or economical.

Another object of the invention is to provide a process for the preparation of inherently coloured polyester polymers, fibers or filaments with controlled branching or even linear structures, where the process is eco-friendly.

Another object of the present invention is to overcome or ameliorate at least one of the disadvantages of the prior arts.

### DETAILED DESCRIPTION OF THE INVENTION

According to the invention there is provided inherently coloured polyester polymers, fibers or filaments comprising chromophoric co-monomer in their backbone with controlled branching or even linear structures.

According to the invention there is provided inherently coloured polyester polymer comprising dicarboxylic acid monomer selected from pure terephthalic acid or isophthalic acid; diol monomer selected from ethylene glycol ethylene glycol, 1:3 propane diol or 1:4 butane diol and ester of chromophoric co-monomer such as ester of metallo phthalocyanine tetracarboxylic acid; the metal is selected from copper, cobalt, nickel, iron or vanadyloxy or any other transition metal.

According to the invention there is also provided a process for the preparation of inherently coloured polyester polymers, fibers or filaments, the process comprising
a. preparing ester of chromophoric co-monomer by treating chromophoric co-monomer with mono-functional alcohol or di-functional alcohol or combinations thereof,
b. preparing a slurry of dicarboxylic acid selected from pure terephthalic acid or isophthalic acid and diol selected from monoethylene glycol, 1,3-propane diol or 1,4-butane diol,
c. adding ester of chromophoric co-monomer into the slurry of step b followed by oligomerizing the above mixture in the presence of Sb₂O₃, under nitrogen pressure of 1.5-1.8 kg/cm² and at temperature of 255 to 260° C.; and
d. polycondensing the oligomer in vacuum at temperature in the range of 280 to 285° C. to obtain polyester and draining the polymer into strands followed by cutting into chips which are extruded and melt spun into filament or fiber.

Inherently coloured polyester obtained from the above process is directly melt spun to obtain coloured filaments or fibers.

According to the invention there also is provided a process for the preparation of inherently coloured polyester polymers, fibers or filaments, the process comprising
a. preparing oligomer of dicarboxylic acid selected from pure terephthalic acid or isophthalic acid and diol selected from monoethylene glycol, 1,3 propane diol or 1,4 butane diol in presence of catalyst, Sb₂O₃, under nitrogen pressure of 1.5-1.8 kg/cm² and at temperature of 255 to 260° C.;
b. preparing ester of chromophoric co-monomer by treating chromophoric co-monomer with mono-functional alcohol or di-functional alcohol or combinations thereof,
c. extruding the oligomer while injecting ester of chromophoric co-monomer at any time after the oligomerization and before the extrusion starts at temperature in the range of 255-285° C. for residence time of 8 to 10 minutes; and
d. polycondensing extruded coloured composition under vacuum at temperature in the range of 280 to 285° C. to obtain inherently coloured polyester polymer followed by draining the polymer into strands and cutting into chips which are extruded and melt spun into filament or fiber.

Inherently coloured polyester obtained from the above process is directly melt spun to obtain filament or fiber.

The block diagram/schematic diagram of the above process is illustrated in FIG. 1.

The chromophoric co-monomer is carboxyl terminated chromophoric co-monomer such as tetracarboxylic metal phthalocyanine. The metal is, but not restricted to copper, cobalt, nickel, iron, calcium, barium, zinc, vanadyl oxy, or any other transition metal. One of the example of carboxyl terminated chromophore co-monomer is tetracarboxylic copper phthalocyanine. The co-monomers here are indicative and those skilled in the art know that any other transition metal may be used to make the phthalocyanine and get the corresponding colour. Those skilled in the art know that the above chromophoric co-monomer may have any of the transition metal as the central ion and may obtain the corresponding colour. The structural formula is given below:

A combination of one or more chromophoric co-monomer can also be used simultaneously in the present invention to give the corresponding coloured polyester.

These chips are converted into filaments by standard method. The filaments thus obtained are tested for standard properties. Alternately the polymer melt can be directly taken through an extruder and filaments may be drawn.

Polymer obtained by the above processes is characterized by measurement of Intrinsic viscosity, copper content and nitrogen content. The polymer is dissolved in hexafluoro isopropanol and filtered to check the presence of unreacted chromophore. There is no residue indicating that there is substantially less unreacted chromophore present in the polymer. The chemical linking of the chromophore in the polymer back bone is further confirmed by Soxlet extraction of the yarn in chloroform for 6 hrs. The colour of the yarn is not changed and no coloured extract is obtained. According to the above characterization, chromophoric co-monomer is present in the polymeric backbone and there is no evidence of presence of free chromophoric co-monomer present in the polymer.

The inherently coloured polymer fiber or filament yarn was tested for wash fastness, rubbing fastness, sublimation fastness and light fastness by conventional method. The results always rated between the scale of 1 to 5. Rating 1 indicates worst fastness and Rating 5 indicates excellent fastness.

According to the invention there is also provided use of above inherently coloured polyester polymer prepared by the above mentioned process in many forms or applications selected from fibres, filaments, woven and non-woven yarns, knitted or moulded articles.

Structural Formula of Metallo Phthalocyanine Tetra Carboxylic Acid

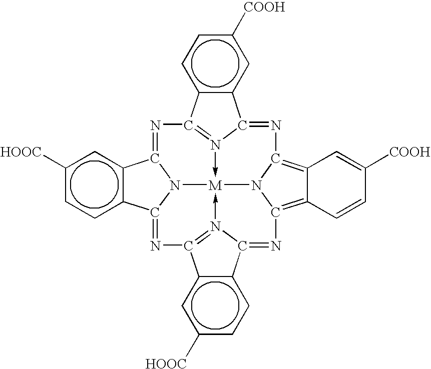

The chromophoric co-monomer is treated with mono-functional alcohol or di-functional alcohol or combinations thereof to obtain ester of chromophoric co-monomer and is used in the above process to control the branching of the inherently coloured polyester polymer and hence eases the spinnability of the polymer without gelling or without damaging filter pack.

Preferably the ester of metallo phthalocyanin tetracarboxylic acid is prepared by treating metallo phthalocyanin tetracarboxylic acid with mono-functional alcohol or di-functional alcohol or combinations thereof. Preferably, mono-functional alcohol is selected from octanol, nonanol, dodecyl alcohol or lauryl alcohol and di-functional alcohol is selected from ethylene glycol or 1,3-propane diol or 1,4-butane diol. Preferably the ratio of chromophoric co-monomer, mono-functional alcohol and di-functional alcohol used is in the range of 1:2:100 to 1:2:300. Preferably, the ester of chromophoric co-monomer is added in the range of 0.1 to 10 percentages by weight. More preferably, the ester of chromophoric co-monomer is added in the range of 0.4 to 2 percentage by weight.

The inherently coloured polyester of the invention is obtained by incorporating ester of chromophoric co-monomer in the backbone of the polymer chain as the chromophoric co-monomer are capable of reacting with monomers. Inherently coloured polyester of the invention eliminates the need for dyeing of polyester fibers or filaments and in turn gives cost benefit and also becomes eco-friendly as it reduces all the emissions related to the step of dyeing and eliminates use of large quantity of water for dyeing. It is also safe to human as it is not degradable in the presence of sunlight and does not leach out the harmful dye. The process also reduces the functionality of tetra functional chromophoric co-monomer to two by reacting with mono-functional alcohol like butanol, octanol, nonanol, dodecyl alcohol or lauryl alcohol or di-functional alcohol like monoethylene glycol, 1,3-propanediol or 1,4-butanediol and thus improves the solubility of chromophoric co-monomer in ethylene glycol and eases the polymerization. The use of tetra carboxyl functional chromophoric co-monomer in which two of the carboxyl functional groups are blocked, yet maintains its thermal stability. The ester of chromophoric co-monomer is directly added to the reactor or extruder as required to obtain inherently coloured polyester. The process steps are simple, easy and convenient to carry out. There is no occurrence of localized gelling or dye carryover, which usually causes problems in down stream processing, making it cost-effective. The process imparts inherent colour to the polymer, hence no extra dyeing step and no use of pigments are required. The process is eco-friendly as it uses less water and no chemical is drained in the stream as compared to the dye house.

Although the invention has been described with reference to specific examples, it will be appreciated by those skilled in the art that the invention may be embodied in many other forms.

### Example 1

### Preparation of Adduct (I): Copper Phthalocyanine Tetra Carboxylic Acid Nonanol-Ethylene Glycol Derivative

A slurry of copper phthalocyanine tetra carboxylic acid (48 gm, 0.06 mole), Monoethylene glycol (1135 gm, 18.3 mole), nonanol (27.6 gm, 0.12 mole) and PTSA catalyst (0.2% by weight based on chromophore) were charged in a Parr reactor. The reaction was carried out at temperature of 250° C. under nitrogen pressure of 3-4 bar with stirring at 100 rpm for 5 hours. The adduct (I) was drained under nitrogen blanket.

### Example 2

### Preparation of Coloured Polyester Comprising 0.5% Chromophore by Adding Adduct I to PTA-MEG Slurry

The adduct (I) prepared according to Example 1 was added to the slurry containing monoethylene glycol (MEG)—purified terephthalic acid (PTA) in molar ratio of 2:1 (MEG:PTA). The Catalyst Sb₂O₃, 400 ppm Sb, was added and the esterification reaction was carried out under nitrogen pressure of 1.7 kg/cm² and at temperature of 260° C. The coloured oligomer thus obtained was then transferred to a polycondensation reactor. Vacuum was applied slowly to the polycondensation reactor and the final vacuum of around 1 mm Hg was obtained in 45 min. The temperature was gradually increased to around 285° C. As the reaction proceeded, the viscosity increased due to polymerization, hence torque and power of the agitator increased. After a certain rise in torque, vacuum was broken and the reactor was pressurized with nitrogen and polymer was drained as strands and quenched in water bath. The strands were then cut into chips in a pelletizer, which were further dried to remove moisture.

### Example 3

### Preparation of Coloured Polyester Comprising 0.5% Chromophore by Adding Adduct I to PTA-MEG Reaction Mixture after Esterification

The slurry of monoethylene glycol (MEG)—purified terephthalic acid (PTA) in molar ratio of 2:1 (MEG:PTA) was prepared. The Catalyst Sb₂O₃, 400 ppm Sb, was added to the slurry and the esterification reaction was carried out under nitrogen pressure of 1.7 kg/cm² and at temperature of 260° C. At the end of esterification, the adduct (I) (prepared according to Example 1) was added to the esterified mixture and stirred for 10-15 minutes before it was transferred to polycondensation reactor. Adduct I was fed as a solution in MEG. The whole system was kept under vacuum. The coloured oligomer thus obtained was then polycondensed. Vacuum was applied slowly to the polycondensation and the final vacuum of around 1 mm Hg was obtained in 45 min. The temperature was gradually increased to around 285° C. As the reaction proceeded, the viscosity increased due to polymerization, hence torque and power of the agitator increased. After a certain rise in torque, vacuum was broken and the reactor was pressurized with nitrogen and polymer was drained as strands and quenched in water bath. The strands were then cut into chips in a pelletizer, which were further dried to remove moisture.

### Example 4

### Preparation of Control Polyester

A slurry of monoethylene glycol (MEG)—purified terephthalic acid (PTA), was prepared in molar ratio of 2:1 (MEG: PTA). The reaction mixture was esterified in the presence of catalyst Sb₂O₃, 400 ppm Sb under nitrogen pressure of 1.7 kg/cm² and at temperature of 260° C. Then the oligomer obtained was polycondensed under nitrogen pressure. Vacuum was applied slowly to the polycondensation and a final vacuum of around 1 mm Hg was obtained in 45 min.

The temperature was gradually increased to 285° C. As the polycondensation proceeded, the viscosity increased due to polymerization, hence torque and power of the agitator also increased. After a certain rise in torque, vacuum was broken and the reactor was pressurized with nitrogen and polymer was drained as strands and quenched in water bath. The strands were then cut into chips in a pelletizer, which were further dried to remove moisture.

These chips prepared according to Examples 2 and 3 were converted into filaments by standard method. The chemical linking of the chromophore in the polymer back bone was further confirmed by Soxhlet extraction of the yarn or filaments in chloroform for 6 hrs. The colour of the yarn was greenish blue. It was not changed after extraction and no colour was obtained in the extract. Characterization of polymers obtained according to the Example 2, 3 and 4 was carried out by measurement of Intrinsic viscosity in Phenol: TCE (60:40 by wt) at 30° C. of the yarn sample and polymer chips. The intrinsic viscosity of polymers of Example 2 and 3 was 0.54 dl/gm and that of control (Example 4) was 0.57 dl/gm.

The polymer was dissolved in hexafluoro isopropanol and filtered. There was no residue indicating that there is no unreacted chromophoric co-monomer present in the polymer. According to the above results, the ester of chromophoric co-monomer was incorporated in the polymeric backbone and there was no free chromophoric co-monomer present in the polymer.

These chips obtained according to Example 2 and Control polyester obtained according to Example 4 were converted into filaments by standard method. The filaments thus obtained were tested for standard mechanical properties tenacity and elongation as illustrated in table 1.

TABLE 1
physical characterization of the yarn

| | Self coloured yarn from | Control yarn from |
|---|---|---|
| Property | example 2 | example 4 |
| Den/fil | 75/36 | 75/36 |
| Tenacity (gpd) | 2.83 | 4.2 |
| Elongation (%) | 36.33 | 27.6 |

The above data indicates that the inherently coloured yarn tenacity and elongation comparable to the control yarn.

These chips prepared according to Examples 2, 3 and 4 (Control yarn) were converted into yarns by standard method. The control yarn was dyed with the same greenish blue colour by the conventional dyeing procedures. The yarns were tested for wash fastness, rubbing fastness, sublimation fastness and light fastness by conventional methods. On a scale of 1 to 5 a rating of 5 is excellent and 1 is the worst. The results of wash fastness and rubbing fastness of inherently coloured yarn prepared according to the Examples 2 and 3 were found to be excellent and comparable with the control yarn prepared according to Example 4. The results of sublimation fastness and light fastness of inherently coloured yarn prepared according to the examples 2 and 3 were found to be superior than the control yarn prepared according to Example 4.

### Example 5

### Preparation of Adduct II: Copper Phthalocyanine Tetra Carboxylic Acid Nonanol-Ethylene Glycol Derivative

A slurry of the copper phthalocyanine tetra carboxylic acid (96 gm, 0.0.12 mole) monoethylene glycol (1135 gm, 18.3 mole) and nonanol (55.2 gm, 0.24 mole) and PTSA catalyst (0.2% by weight based on chromophore) was prepared. The reaction was carried out under stirring at 100 rpm in a Parr reactor at temperature of 250° C. and under nitrogen pressure of 3-4 bar for 5 hours. The product obtained was drained under nitrogen blanket and is referred to as adduct II.

### Example 6

### Preparation of Coloured Polyester Containing 1.0% Chromophore by Adding Adduct II to PTA-MEG Slurry

Adduct II (prepared according to example 5) is added to the slurry of monoethylene glycol (MEG)—purified terephthalic acid (PTA) in molar ratio of 2:1 (MEG:PTA). The Catalyst Sb₂O₃, 400 ppm Sb, was added and the esterification reaction was carried out under nitrogen pressure of 1.7 kg/cm² and at temperature of 260° C. The coloured oligomer thus obtained was then transferred to a polycondensation reactor. Vacuum was applied slowly to the polycondensation reactor and the final vacuum of around 1 mm Hg was obtained in 45 min. The temperature was gradually increased to around 285° C. As the reaction proceeded, the viscosity increased due to polymerization, hence torque and power of the agitator increased. After a certain rise in torque, vacuum was broken and the reactor was pressurized with nitrogen and polymer was drained as strands and quenched in water bath. The strands were then cut into chips in a pelletizer, which were further dried to remove moisture.

### Example 7

### Preparation of Coloured Polyester Containing 1.0% Chromophore by Adding Adduct II to PTA-MEG Reaction Mixture After Esterification

The slurry of monoethylene glycol (MEG)—purified terephthalic acid (PTA) in molar ratio of 2:1 (MEG:PTA) was prepared. The Catalyst Sb₂O₃, 400 ppm Sb, was added to the slurry and the esterification reaction was carried out under nitrogen pressure of 1.7 kg/cm² and at temperature of 260° C. At the end of esterification, the adduct (II) (prepared according to Example 5) was added to the esterified mixture and stirred for 10-15 minutes before it was transferred to polycondensation reactor. Adduct II was fed as a solution in MEG. The whole system was kept under vacuum. The coloured oligomer thus obtained was then polycondensed. Vacuum was applied slowly to the polycondensation reactor and the final vacuum of around 1 mm Hg was obtained in 45 min. The temperature was gradually increased to around 285° C. As the reaction proceeded, the viscosity increased due to polymerization, hence torque and power of the agitator increased. After a certain rise in torque, vacuum was broken and the reactor was pressurized with nitrogen and the polymer was drained and the strands were quenched in water bath. The strands were then cut into chips in a pelietiser which was further dried to remove moisture.

These chips according to Examples 6 and 7 were converted into filaments by standard method. The chemical linking of the chromophore in the polymer back bone was further confirmed by soxhlet extraction of the yarn or filaments in chloroform for 6 hrs. The colour of the yarn was greenish blue. It was not changed even after the extraction and no colour was obtained in the extract. Characterization of polymer according to Examples 6, 7 and 4 was carried out by measurement of Intrinsic viscosity at 30° C. dl/gm (phenol: TCE 60:40 by wt). The intrinsic viscosity of polymer of Example 6 and 7 was 0.57 dl/gm and that of control Example 4 was 0.57 dl/gm.

The polymer according to Examples 6 and 7 was dissolved in hexafluoro isopropanol and filtered. There was no residue indicating that there was no unreacted chromophore present in the polymer. According to the above results, the ester of chromophoric co-monomer was incorporated in the polymeric backbone and there was no free chromophoric co-monomer present in the polymer.

These chips were converted into filaments by standard method. The filaments thus obtained were tested for standard mechanical properties—tenacity and elongation and these properties were comparable to control yarn.

These chips prepared according to Examples 6 and 7 were converted into yarns by standard method. The yarns were tested for wash fastness, rubbing fastness, sublimation fastness and light fastness by conventional method and compared with the dyed control yarn prepared according to the Example 4, which was dyed with the same greenish blue color by the conventional dyeing procedures. On a scale of 1 to 5 a rating of 5 is excellent and 1 is the worst.

The results of wash fastness and rubbing fastness of inherently coloured yarn prepared according to the Examples 6 and 7 were found to be excellent and comparable with the control yarn prepared according to Example 4. The results of sublimation fastness and light fastness of inherently coloured yarn prepared according to the examples 6 and 7 were found to be superior than the control yarn prepared according to Example 4.

### Example 8

### Preparation of Adduct III: Nickel Phthalocyanine Tetra Carboxylic Acid Nonanol-Ethylene Glycol Derivative

Nickel phthalocyanine tetra carboxylic acid nonanol-ethylene glycol derivative (adduct III) was prepared according to Example 1 using nickel phthalocyanine tetra carboxylic acid instead of copper phthalocyanine tetra carboxylic acid.

Preparation of Coloured Polyester Comprising 0.5% Chromophore by Adding Adduct III to PTA-MEG Reaction Mixture after Esterification

Polymer was prepared according to example 3 using adduct III instead of adduct I.

Characterization of polymer according to Example 8 was carried out by measurement of Intrinsic viscosity at 30° C. dl/gm (phenol: TCE 60:40 by wt). Intrinsic viscosity was 0.54 and control sample was 0.57 dl/gm.

These chips were converted into filaments by standard method. The colour of the yarn was bluish green.

The filaments thus obtained were tested for standard mechanical properties—tenacity and elongation and these properties were comparable to control yarn.

These chips prepared according to Example 8 were converted into yarns by standard method. The yarns was tested for wash fastness, rubbing fastness, sublimation fastness and light fastness by conventional method and compared with the dyed control yarn prepared according to the example 4, which was dyed with bluish green colour by the conventional procedures. On a scale of 1 to 5 a rating of 5 is excellent and 1 is the worst.

The results of wash fastness and rubbing fastness of inherently coloured yarn prepared according to the Example 8 were found to be excellent and comparable with the control yarn prepared according to Example 4. The results of sublimation fastness and light fastness of inherently coloured yarn prepared according to the example 8 were found to be superior than the control yarn prepared according to Example 4.

### Comparative Example

### Preparation of Coloured Polyester Containing 0.5% Chromophore without Using Adduct

Copper phthalocyanine tetra carboxylic acid and MEG were mixed at 2% w/w concentration and was milled in a ball mill for 60 min to get size below 1μ. (40 gms in 1960 gms of MEG). The slurry was filtered through 5μ sieve. This slurry was added to a slurry of monoethylene glycol (MEG)—purified terephthalic acid (PTA) prepared in molar ratio of 2:1 (MEG: PTA), so that the final concentration of the chromophore in the polymer was ±0.5 wt in polymer. The reaction mixture was esterified in the presence of catalyst Sb₂O₃ (400 ppm Sb) under nitrogen pressure of 1.7 kg/cm² and at temperature of 260° C. The coloured oligomer thus obtained was subjected to a polycondensation under vacuum of 1 mm Hg and the temperature about 285° C. As the polycondensation reaction proceeded, the viscosity increased due to polymerization, hence torque and power of the agitator increased. After a certain rise in torque, vacuum was broken and the reactor was pressurized with nitrogen and polymer was drained as strands and quenched in water bath. The strands were then cut into chips in a pelletizer, which were further dried to remove moisture.

These chips were converted into filaments by melt spinning. The spin pack pressure was increased during spinning. There were breaks in the fiber. The colour of the free fall yarn was bluish green. The yarn was analysed for insoluble solids by dissolving in HFIP and filtering the same. 0.04% insoluble solids obtained indicating that about 1% of the total chromophore added remains unreacted in the polymer and gets filtered during spinning causing high spin pack pressure. Moreover, these particles also cause spin breaks.

1-16. (canceled)

17. Inherently colored polyester polymers with controlled branching, wherein the polymers have a backbone comprising a chromophoric co-monomer.

18. The inherently colored polyester polymers of claim 17, wherein the chromophoric co-monomer is a carboxyl terminated chromophoric co-monomer.

19. The inherently colored polyester polymers of claim 18, wherein the carboxyl terminated chromophoric co-monomer is metallo-phthalocyanine tetracarboxylic acid.

20. The inherently colored polyester polymers of claim 19, wherein the metallo-phthalocyanine tetracarboxylic acid includes a metal that is selected from the group consisting of copper, cobalt, nickel, iron, calcium, barium, zinc, vanadyloxy, and any other transition metal.

21. The inherently colored polyester polymers of claim 17, wherein the polyester polymer comprises:
a dicarboxylic acid monomer selected from the group consisting of pure terephthalic acid and isophthalic acid;
a diol monomer selected from the group consisting of ethylene glycol, 1:3 propane diol, and 1:4 butane diol; and
an ester of metallo-phthalocyanine tetracarboxylic acid, wherein the metal is selected from the group consisting of copper, cobalt, nickel, iron, calcium, barium, zinc, vanadyloxy, and any other transition metal.

22. The inherently colored polyester polymers of claim 21, wherein the ester of metallo-phthalocyanine tetracarboxylic acid is prepared by treating metallo-phthalocyanine tetracarboxylic acid with an alcohol selected from the group consisting of a mono-functional alcohol, di-functional alcohol, and combinations thereof.

23. The inherently colored polyester polymers of claim 22, wherein the mono-functional alcohol is selected from the group consisting of octanol, nonanol, dodecyl alcohol, and lauryl alcohol; and wherein the di-functional alcohol is selected from the group consisting of ethylene glycol, 1,3-propane diol, and 1,4-butane diol.

24. The inherently colored polyester polymers of claim 17, wherein the chromophoric co-monomer is provided as an ester of a chromophoric co-monomer in the range of about 0.1 percent to about 10 percent by weight.

25. A process for the preparation of a filament or fiber from an inherently colored polyester polymer, the process comprising:
a. preparing an ester of a chromophoric co-monomer by treating the chromophoric co-monomer with an alcohol selected from the group consisting of mono-functional alcohol, di-functional alcohol, and combinations thereof;
b. preparing a slurry of a dicarboxylic acid, wherein the dicarboxylic acid is selected from a group consisting of pure terephthalic acid and isophthalic acid, and wherein the diol is selected from the group consisting of monoethylene glycol, 1,3-propane diol, and 1,4-butane diol;
c. forming a mixture of the ester of chromophoric co-monomer and the slurry of step b followed by oligomerizing the mixture in the presence of Sb₂O₃ as a catalyst under nitrogen pressure of 1.5-1.8 kg/cm² and at a temperature of 255 to 260° C. to form an oligomer; and
d. poly-condensing the oligomer in a vacuum at a temperature in the range of 280 to 285° C. to obtain a polyester polymer; and
e. melt-spinning the polymer into a filament or fiber.

26. A process for the preparation of a filament or fiber from an inherently colored polyester polymer, the process comprising:
a. preparing an oligomer of dicarboxylic acid and diol in the presence of Sb₂O₃ as a catalyst, under nitrogen pressure of 1.5-1.8 kg/cm² and at a temperature of 255 to 260° C., wherein the dicarboxylic acid is selected from a group consisting of pure terephthalic acid and isophthalic acid; and the diol is selected from the group consisting of monoethylene glycol, 1,3 propane diol, and 1,4 butane diol;
b. preparing an ester of a chromophoric co-monomer by treating the chromophoric co-monomer with an alcohol selected from a group consisting of a mono-functional alcohol, a di-functional alcohol, and any combination thereof;
c. extruding the oligomer while injecting the ester of chromophoric co-monomer at a temperature in the range of 255-285° C. for a residence time of 8 to 10 minutes to provide an extruded colored composition; and
d. polycondensing the extruded colored composition under vacuum at a temperature in the range of 280 to 285° C. to obtain an inherently colored polyester polymer; and
e. melt-spinning the polymer into a filament or fiber.

27. The process of either of claim 25 or 26, wherein the melt-spinning step comprises the sub-steps of:
e. 1. draining the inherently colored polyester polymer into strands;
e. 2. cutting the strands into chips; and
e. 3. extruding and melt-spinning the chips into a filament or fiber.

28. The process of either of claim 25 or 26, wherein the chromophoric co-monomer is a carboxyl terminated chromophoric co-monomer.

29. The process of claim 28, wherein the carboxyl terminated chromophoric co-monomer is metallo-phthalocyanine tetracarboxylic acid.

30. The process of claim 29, wherein the metallo-phthalocyanine tetracarboxylic acid includes a metal that is selected from the group consisting of copper, cobalt, nickel, iron, calcium, barium, zinc, vanadyloxy, and any other transition metal.

31. The process of either of claim 25 or 26, wherein the mono-functional alcohol is selected from the group consisting of octanol, nonanol, dodecanol, and lauryl alcohol; and wherein the di-functional alcohol is selected from the group consisting of ethylene glycol, 1,3-propane diol, and 1,4-butane diol.

32. The process of either of claim 25 or 26, wherein the ester of chromophoric co-monomer is added in the range of 0.1 percent to 10 percent by weight.

33. The use of the inherently colored polyester polymer of claim 17 to form a product selected from the group consisting of fibers, filaments, woven yarns, non-woven yarns, knitted articles, and molded articles.

34. Yarns prepared from the inherently colored polyester polymer as claimed in claims 17-24, having excellent wash fastness, light fastness, sublimation fastness, and rubbing fastness.
